(19) United States
(12) Patent Application Publication
(10) Pub. No.: US 2009/0102082 A1
(43) Pub. Date: Apr. 23, 2009

(54) Self-Controlled Solenoid Valve Device

(76) Inventors: Andre Gattolliat, Grand-Lancy (CH); Thierry Forestier, Bellegarde (FR)

Correspondence Address: PARKER-HANNIFIN CORPORATION;HUNTER MOLNAR BAKER MORGAN, 6035 PARKLAND BOULEVARD, CLEVELAND, OH, 44124-4141, US

(21) Appl. No.: 11/791,132

(22) PCT Filed: Nov. 16, 2005
(86) PCT No.: PCT/IB2005/003420

§ 371 Date: May 18, 2007

(30) Foreign Application Priority Data
Nov. 19, 2004 (FR) 04/12297

(51) Int. Cl. B29C 31/00; B29C 45/17

(52) U.S. Cl. 264/40.3; 251/129.15

(57) ABSTRACT

A solenoid valve device including a solenoid valve and a choke. The solenoid valve device also including a pressure sensor connected to a control device, which transmits opening and closing signals to the solenoid valve. The control device also transmits signals for automatically setting the choke.

### FIELD OF THE INVENTION

The invention relates to a solenoid valve device for applications requiring good control of a curve for development of pressure caused by opening or closing phases of the solenoid valve. This device is more particularly suited to an application for the preblowing phase or more generally for the blowing part of the manufacturing method for polyethylene terephthalate bottles. The invention also relates to an associated method.

### BACKGROUND OF THE INVENTION

In the prior art, the preblowing phase of the manufacturing method for polyethylene terephthalate bottles takes place as follows:
a solenoid valve, connected to a blank of a bottle to be manufactured, receives an electric opening signal from the overall bottle manufacturing system. Following this command, the solenoid valve opens and allows a gas, coming from a source of low pressure, for example 3 bar, to pass through, which then enters into the bottle blank. The solenoid valve takes time to react and the actual start time of the preblowing phase is delayed in relation to the signal from the overall system;
the pressure then rises progressively in the bottle according to a particular incline until it reaches the final preblowing pressure which is equal to 3 bar in this example.

In a manner which is simultaneous to and coordinated with the operation of the solenoid valve and the increase in the pressure of the gas in the bottle, a drawing shaft pushes the bottom of the bottle during this whole phase to give the bottle the desired shape.

The solenoid valves of the prior art have the following disadvantages for this application:
depending on their wear and individual features, the time that passes between the signal from the overall system and the actual opening of the solenoid valve varies and changes according to the time for a given solenoid valve. As a result, the preblowing start time is uncertain, and this does not allow for good coordination with the movement of the stretching shaft and for good control of the bottle manufacturing process;
likewise, the pressure increase slope is not perfectly controlled. Nowadays, it can be modified by the manual setting of a choke positioned at the input to the solenoid valve. However, this setting is done manually and intuitively by an operator on the basis of a visual diagnostic by the operator according to the bottles obtained. The result is a slope that is barely controlled and as a result the duration of the preblowing phase is uncertain, which engenders the same problems as those of the previous point;
finally, the end of this phase is reached when the pressure is stabilized at the gas source pressure value, i.e. 3 bar according to the previous example. After this preblowing phase, the bottle manufacturing method continues with blowing of a gas at high pressure. The solenoid valve must therefore operate with two different sources of pressure, which is a disadvantage.

The aim of the invention is to propose a solenoid valve device and a blowing method which does not have the aforementioned disadvantages.

More precisely, a first object of the invention consists in proposing a solenoid valve device allowing for better control of the pressure increase phase following an opening command.

A second object of the invention consists in proposing a solenoid valve device allowing operation with possibly a single source of high pressure.

A third object of the invention consists in proposing a better controlled blowing method, suited for example to the manufacture of a polyethylene terephthalate bottle.

The invention is based on a solenoid valve device including a solenoid valve and a choke, characterized in that it includes a pressure sensor connected to a control device, a connection between the control device and the solenoid valve for transmitting thereto an opening and/or closing signal, a connection between the control device and an actuator for the choke for transmitting thereto a signal for automatically setting the choke.

The control device can include a microprocessor capable of implementing a control software and a memory capable of storing a history of the measured values. Furthermore, the control device can include a connection to the exterior capable of receiving an opening control signal.

The choke may include a pressure equalizing means promoting the action of the actuator, where the latter may be a linear stepping motor according to an alternative embodiment.

The solenoid valve may include a nonreturn valve.

The invention also relates to a blowing method, characterized in that it includes, for each blowing phase, the following steps:
measurement of the initial actual time by a sensor, with transmission to a control device and recording in a memory;
measurement of the pressure increase slope, with transmission to a control device and recording in a memory;
measurement of the blowing final pressure, with transmission to a control device and recording in a memory;
   and in that it includes the following steps between each blowing phase:
comparison, by software of the control device, of the three previous measurements with a history recorded in the memory and automatic readjustment in the case of deviation.

This blowing method can include the periodic measurement of the pressure by a pressure sensor, the transmission of the values to the control device and the storage of some of these values as well as the associated time.

It can also include the following initial steps;
opening control signal transmitted to the solenoid valve device;
opening control signal transmitted by a control device to the solenoid valve after a determined idle time;
   and characterized in that readjustment of the idle time is undertaken to ensure a constant duration between the opening control signal from the exterior system and the actual start time of the preblowing phase.

According to an embodiment, the blowing method includes a readjustment, in the case of deviation of the pressure curve slope, which consists in a command transmitted by the control device to a linear actuator so as to modify the setting of a choke.

According to an embodiment, the blowing method includes a readjustment, in the case of deviation of the blowing final pressure, which consists in modifying the moment of transmission of the command for closing the solenoid valve.

According to the invention, this method can be applied to the manufacture of polyethylene terephthalate bottles.

### DESCRIPTION OF THE DRAWINGS

These objects, features and advantages of the present invention shall be disclosed in detail in the following description of a particular, non-limiting embodiment with respect to the appended figures wherein:

FIG. 1 shows a functional diagram of a solenoid valve device according to one embodiment of the invention;

FIG. 2 shows a pressure curve as well as the signals from the system and from the control device according to time, in accordance to the method of the invention;

FIG. 3 shows a section of a solenoid valve device according to an embodiment;

FIG. 4 shows a flow diagram showing the different operational phases of a device according to the invention.

### DETAILED DESCRIPTION OF THE INVENTION

One particular embodiment of the invention for an application within the field of polyethylene terephthalate bottle manufacture is described hereafter.

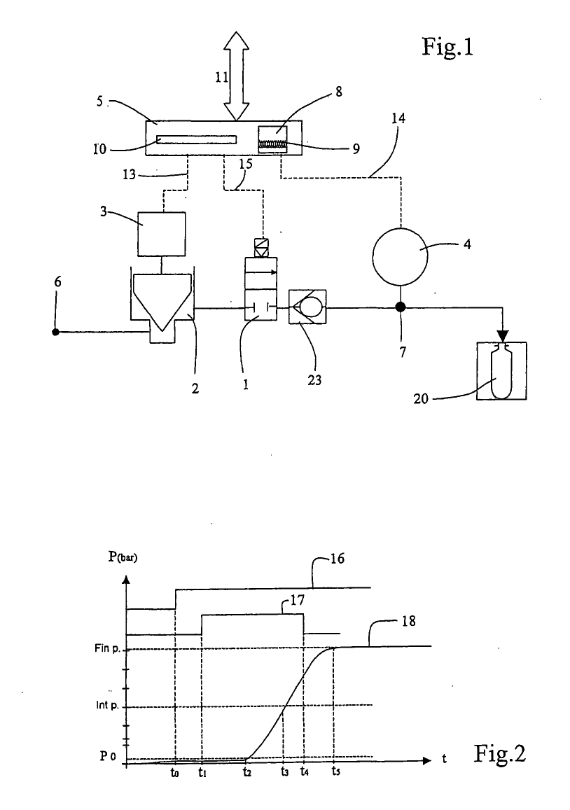

According to this embodiment illustrated in the functional diagram of FIG. 1, the solenoid valve device includes a solenoid valve 1, a choke 2, an actuator 3 for the choke 2, a pressure sensor 4 and a control device 5. The solenoid valve device is connected at input 6 to a gas source, whereby the gas can be passed through the choke 2, the solenoid valve 1 and the pressure sensor 4 successively to arrive finally at output 7 of the device, the output being connected for example to a polyethylene terephthalate bottle blank 20 to be manufactured. The control device 5 is an electronic device essentially made up of a microprocessor 8 executing software 9, a memory 10 and a clock which is not illustrated. It can exchange data with the exterior system via a connection 11, and is connected to the actuator 3 (connection 13), the solenoid valve 1 (connection 15) and the sensor 4 (connection 14).

During each preblowing phase of a polyethylene terephthalate bottle, which is shown by the time diagram in FIG. 2, the control device receives a signal from the exterior system via the connection 11, at a moment t0, shown on the curve 16 of FIG. 2, giving it the go-ahead to initiate the preblowing cycle. The control device 5 then transmits the command to the solenoid valve via the connection 15, at the moment t1 illustrated by the curve 17 in FIG. 2, at the end of an idle period t1-t0, of between 20 and 50 milliseconds.

Then, the sensor 4 measures the pressure periodically, for example every 500 microseconds, and transmits the measurements via the connection 14 to the control device 5. The latter stores in the memory 10 certain value couples for pressure and the associated time, according to a predefined rhythm. For example, the times for the pressure values of 0.5 bar, 3 bar and 6 bar can be stored in one implementation wherein the desired final pressure is equal to 6 bar. The memory 10 will thus store these values in order to develop a history, which includes for example the values of the last ten preblowing cycles.

Finally, at a pre-defined moment t4, the control device 5 transmits a closing signal to the solenoid valve 1. The pressure then stabilizes progressively at the time t5 at a final value of 6 bar. The obtained pressure curve 18 is illustrated in FIG. 2.

Between two preblowing cycles, the software 9 of the control device 5 analyses the last recorded data and compares them to the already stored history. This analysis concerns the following data:
the duration between the opening signal from the overall system and the actual start of the preblowing cycle, the duration being equal to the calculation t2-t0, t2 being detected for an extremely low value PO of pressure, of 0.5 bar in this example. In the case of deviation of this data, which is detected by the analysis of the history, the software 9 takes a readjustment step which consists in modifying the duration between the reception of the start signal from the system and the transmission of the opening signal by the control device (idle time t1-t0). The aim of this readjustment is to guarantee a completely constant duration between the start signal given by the system and the actual start of preblowing (t2-t0). This readjustment can be achieved using the following calculation implemented by the software 9:

T1n=T1n−1+(T2−T2n−1), where
T1n: represents the duration (t1-t0) between the signal from the system and the opening signal for the next cycle n;
T1n−1: represents this duration at the cycle n−1;
T2: represents the desired duration (t2-t0) between the opening signal from the overall system and the actual start of the preblowing cycle;
T2n−1: represents the duration (t2-t0), measured at the cycle n−1, between the opening signal from the overall system and the actual start of the preblowing cycle;
the slope of the increase curve for the pressure, calculated using the measurement of the intermediate pressure Intp of 3 bar (at t=t3) and the measurement of the starting point of the curve (at t=t2). Just as for the previous data, the software 9 will detect a possible deviation of this data and will then take a readjustment step if necessary. To do so, it will influence the setting of the position of the choke 2 by sending commands via the connection 13 to the actuator 3, which allows automatic setting. An example of such a readjustment consists in applying the following formula:

Position_rest_{—}n=Position_rest_{—}n−1+G1(T3−T3n−1); where
Position_rest_n: represents the position of the choke for the next cycle;
Position_rest_n−1: represents this same value at the previous cycle;
G1: represents a linear coefficient or, in an alternative, a complex gain (for example a PID corrector);
T3: represents the duration (t3-t2) between the actual start of the increase in pressure and the intermediate pressure Intp of 3 bar;
T3n−1: represents this same duration measured at the previous cycle;
the final preblowing pressure Finp, which depends on the moment t4 of closing the solenoid valve, for a constant input pressure and a constant pressure increase slope. Just as for the two previous data, the software 9 will detect a possible deviation of this data and will readjust the closing moment of the solenoid valve, according to the following calculation for example:

T4n=T4n−1+G2(Finp−Finp_{—}n−1); where
T4n: represents the duration (t4-t1) between the signals for opening and closing the solenoid valve;
T4n−1: represents this same duration at the previous cycle;
G2: represents a linear coefficient or, in an alternative, a complex gain (for example a corrector PID);
Finp: represents the desired final pressure, of 6 bar in this example;
Finp_n−1: represents the final pressure measured at cycle n−1.

All these measurements and data are illustrated in FIG. 2 in which the first curve 16 corresponds to the signal coming from the overall system, which is external to the solenoid valve device of the invention, showing an opening signal at the time t0. The second curve 17 corresponds to the signals for opening and closing the solenoid valve which are transmitted by the control device 5 at the times t1 and t4 respectively, and the third curve 18 illustrates the increase in pressure measured by the sensor 4 at output from the solenoid valve.

The operating principle of the device is therefore based on the monitoring thereof between each use, on the basis of a historical tracking of data characterizing it. This principle is different to real time monitoring according to a theoretical reference curve. The calculations given in the previous example can be different, take into account for example values of several past cycles, use more complex and not necessarily linear equations, in order to suit notably the features of the material used. The method can thus allow good results to be obtained even when there is a fluctuating value for the high input pressure, the effect being reduced by the chosen setting calculation. It should be noted that the results measured during exceptional events such as breaking of the bottle are not recorded because they are not significant and an output signal indicates to the client that the desired pressure profile has not been achieved according to the defined acceptability criteria (tolerances) to allow him to carry out automatic sorting of the bottles (scrapped if faulty) and/or to not carry out the following blowing phase.

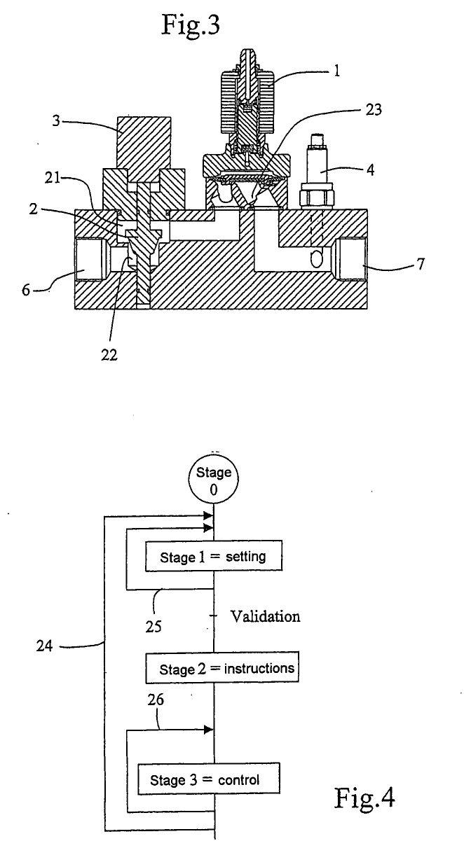

FIG. 3 more precisely illustrates the structure of a device according to the invention. The actuator 3 is a linear stepping motor which allows for the transverse movement of a shaft affecting the setting of the choke 2. To avoid having to use an extremely powerful motor in the case of the presence of high pressure gas in the device, equalization of the pressure forces is provided for on either side of the choke, in the chambers 21 and 22, to prevent a possible high pressure from opposing the movement of the motor. Furthermore, although it is recommended that the motor be put in economy mode by reducing its supply to prevent temperature rises during the phases where it is not in operation, it will be put in full-power mode during the preblowing phase in order to guarantee setting of the choke remains unaffected, the motor taking on, then, a braking function, opposing the pressure forces which apply during this phase. In an alternative embodiment, any linear actuator could suit without departing from the scope of the invention.

Furthermore, the solenoid valve 1 is equipped with an nonreturn valve 23 to prevent gas circulation in an opposite direction in case of inversion of the pressure forces between the input and output of the device, in the cases where the device is used for example with two input sources, of low and high pressure.

The device of the invention also brings an advantage in the initialization phase, for example following its first use (stage 0) or a change of its environment (return 24), as is illustrated in FIG. 4. Indeed, the device transmits the pressure measurement data to the exterior via the connection 11, which allows an operator to know the real pressure increase curve at each trial and to improve his settings (stage 1) through several iterations (arrow 25). When a trial is conclusive and validated, it is possible to assign an initial setting or instructions for the choke, the idle time and the closing time through manual entry of these data into the control device 5 (stage 2). The device can then enter into iterative (arrow 26), controlled (stage 3) operating mode, as described above.

The invention also relates to a preblowing method for the manufacture of bottles, which includes the following steps for each preblowing phase:
measurement of the initial actual time t2;
measurement of the pressure increase slope;
measurement of the preblowing final pressure.

Then, between each preblowing phase, the method includes the following steps:
comparison of the three previous measurements with a history and automatic readjustment in the case of deviation.

Thus, the solenoid valve device described above allows the desired objects to be easily achieved. It independently detects the differences in its timing behavior and independently readjusts the instructions given initially so as to maintain a constant behavior, and ensure an ideal yield or pressure curve.

The invention has been disclosed above within the scope of an application to the blowing process of polyethylene terephthalate bottles but its concept can also be used in any other application requiring control of the creation of pressure profiles in a repetitive manner in a deformable or nondeformable volume. For example, it could be implemented in any pneumatic clamping element, such as a jack or a pincer.

1. A solenoid valve device including a solenoid valve (1) and a choke (2), characterized in that it comprises a pressure sensor (4) connected (14) to a control device (5), a connection (15) between the control device (5) and the solenoid valve (1) for transmitting thereto an opening and/or closing signal, a connection (13) between the control device (5) and an actuator (3) for the choke (2) for transmitting thereto a signal for automatically setting the choke (2).

2. The solenoid valve device according to claim 1, characterized in that the control device (5) comprises a microprocessor (8) capable of implementing a control software (9) and a memory (10) capable of storing a history of the measured values.

3. The solenoid valve device according to claim 2, characterized in that the control device (5) comprises a connection (11) to the exterior capable of receiving an opening control signal.

4. The solenoid valve device according to claim 1 characterized in that the choke (2) comprises a pressure equalizing means promoting the action of the actuator (3).

5. The solenoid valve device according to claim 1 characterized in that the actuator (3) is a linear stepping motor.

6. The solenoid valve device according to claim 1 characterized in that the solenoid valve comprises a nonreturn valve (23).

7. A blowing method, characterized in that it comprises, for each blowing phase, the following steps:
measurement of the initial actual time by a sensor (4), with transmission to a control device (5) and recording in a memory (10);
measurement of the pressure increase slope, with transmission to a control device (5) and recording in a memory (10);
measurement of the blowing final pressure, with transmission to a control device (5) and recording in a memory (10);
and in that it comprises the following steps between each blowing phase:
comparison, by a software (9) of the control device (5), of the three previous measurements with a history recorded in the memory (10) and automatic readjustment in the case of deviation.

8. The blowing method according to claim 7, characterized in that it comprises the periodic measurement of the pressure by a pressure sensor (4), the transmission of the values to the control device (5) and the storage of some of these values as well as the associated time.

9. The blowing method according to claim 7, characterized in that it comprises the following initial steps:
opening control signal transmitted to the solenoid valve device;
opening control signal transmitted by a control device to the solenoid valve after a determined idle time;
and characterized in that a readjustment of the idle time is undertaken to ensure a constant duration between the opening control signal from the exterior system and the actual start time of the preblowing phase.

10. The blowing method according to claim 7, characterized in that a readjustment, in the case of deviation of the pressure curve slope, consists in a command transmitted by the control device (5) to a linear actuator (3) so as to modify the setting of a choke (2).

11. The blowing method according to claim 7, characterized in that a readjustment, in the case of deviation of the blowing final pressure, consists in modifying the moment of transmission of the command for closing the solenoid valve.

12. A manufacturing method for polyethylene terephthalate bottles, characterized in that it comprises a blowing method according to claim 7.
